(19) United States
(12) Patent Application Publication
(10) Pub. No.: US 2024/0213916 A1
(43) Pub. Date: Jun. 27, 2024

(54) Conjoined Solar Module, and a Joining Unit for Conjoining Multiple Solar Panels

(71) Applicant: SOLARPAINT LTD., YOKNEAM ILLIT (IL)

(72) Inventors: Eran Maimon, Kibbutz Nahsholim (IL); Tomer Roth, Kibbutz Nahsholim (IL); Haggai Manor, Beit Lehem HaGlilit (IL)

(21) Appl. No.: 18/602,069

(22) Filed: Mar. 12, 2024

Related U.S. Application Data
(63) Continuation of application No. PCT/IL2022/050998, filed on Sep. 18, 2022.
(63) Continuation-in-part of application No. 18/129,865, filed on Apr. 2, 2023.
Application No. 18/129,865 is a continuation of application No. PCT/IL2021/051202, filed on Oct. 7, 2021.
Application No. PCT/IL2021/051202 is a continuation-in-part of application No. 17/353,867, filed on Jun. 22, 2021, now Pat. No. 11,978,815.
Application No. 18/129,865 is a continuation-in-part of application No. 17/353,867, filed on Jun. 22, 2021, now Pat. No. 11,978,815.
Application No. 17/353,867 is a continuation-in-part of application No. 16/362,665, filed on Mar. 24, 2019, now Pat. No. 11,081,606.
Application No. 17/353,867 is a continuation-in-part of application No. PCT/IL2019/051416, filed on Dec. 26, 2019.
Application No. PCT/IL2019/051416 is a continuation-in-part of application No. 16/362,665, filed on Mar. 24, 2019, now Pat. No. 11,081,606.
Application No. 18/129,865 is a continuation-in-part of application No. 17/802,335, filed on Aug. 25, 2022.
(60) Provisional application No. 63/245,940, filed on Sep. 20, 2021.
(60) Provisional application No. 63/088,535, filed on Oct. 7, 2020.
(60) Provisional application No. 62/785,282, filed on Dec. 27, 2018.
(60) Provisional application No. 62/785,282, filed on Dec. 27, 2018.
(60) Provisional application No. 62/982,536, filed on Feb. 27, 2020.

(51) Int. Cl. H02S 30/10; H02S 20/00; H02S 30/20

(52) U.S. Cl. CPC H02S 30/10; H02S 20/00; H02S 30/20

(57) ABSTRACT

Conjoined solar module, and a joining unit for conjoining multiple solar panels. A mechanical joining unit has two back-to-back elongated rails. The first elongated rail has an elongated hollow cavity, and receives therein a set of beads or mushroom-shaped protrusions or lollipop-shaped protrusions that are connected to an edge of a first solar panel. Similarly, the second elongated rail has an elongated hollow cavity, and receives therein a set of beads or mushroom-shaped protrusions or lollipop-shaped protrusions that are connected to an edge of a second solar panel. Optionally, the mechanical joining unit has an additional elongated rail that defines an elongated cavity for storing metal wires that transport electricity generated by the solar panels. Optionally, each solar panel is flexible or rollable.

### CROSS-REFERENCE TO RELATED APPLICATIONS

This patent application is a Continuation of PCT/IL2022/050998, having an International Filing Date of Sep. 18, 2022, which is hereby incorporated by reference in its entirety; which claims priority and benefit from U.S. 63/245,940, filed on Sep. 20, 2021, which is hereby incorporated by reference in its entirety.

This patent application is also a Continuation-in-Part (CIP) of U.S. Ser. No. 18/129,865, filed on Apr. 2, 2023, which is hereby incorporated by reference in its entirety.

The above-mentioned U.S. Ser. No. 18/129,865 is a Continuation of PCT international patent application number PCT/IL2021/051202, having an international filing date of Oct. 7, 2021, which is hereby incorporated by reference in its entirety.

The above-mentioned PCT/IL2021/051202 claims priority and benefit: (i) from U.S. 63/088,535, filed on Oct. 7, 2020, which is hereby incorporated by reference in its entirety; and (ii) from U.S. Ser. No. 17/353,867, filed on Jun. 22, 2021, which is hereby incorporated by reference in its entirety.

The above-mentioned U.S. Ser. No. 18/129,865 is also a Continuation-in-Part (CIP) of U.S. Ser. No. 17/353,867, filed on Jun. 22, 2021, which is hereby incorporated by reference in its entirety.

The above-mentioned U.S. Ser. No. 17/353,867 is a Continuation-in-Part (CIP) of U.S. Ser. No. 16/362,665, filed on Mar. 24, 2019, now U.S. Pat. No. 11,081,606 (issued on Aug. 3, 2021), which is hereby incorporated by reference in its entirety; which claims priority and benefit from U.S. 62/785,282, filed on Dec. 27, 2018, which is hereby incorporated by reference in its entirety.

The above-mentioned U.S. Ser. No. 17/353,867 is also a Continuation-in-Part (CIP) of PCT international application number PCT/IL2019/051416, having an international filing date of Dec. 26, 2019, which is hereby incorporated by reference in its entirety.

The above-mentioned PCT/IL2019/051416 claims priority and benefit: (i) from U.S. Ser. No. 16/362,665, filed on Mar. 24, 2019, now U.S. Pat. No. 11,081,606 (issued on Aug. 3, 2021), which is hereby incorporated by reference in its entirety, and (ii) from U.S. 62/785,282, filed on Dec. 27, 2018, which is hereby incorporated by reference in its entirety.

The above-mentioned U.S. Ser. No. 18/129,865 is also a Continuation-in-Part (CIP) of U.S. Ser. No. 17/802,335, filed on Aug. 25, 2022, which is hereby incorporated by reference in its entirety; which is a National Stage of PCT international application number PCT/IL2021/050217, having an international filing date of Feb. 25, 2021, which is hereby incorporated by reference in its entirety; which claims priority and benefit from U.S. 62/982,536, filed on Feb. 27, 2020, which is hereby incorporated by reference in its entirety.

### FIELD

Some embodiments relate to the field of solar panels and photovoltaic (PV) devices.

### BACKGROUND

The photovoltaic (PV) effect is the creation of voltage and electric current in a material upon exposure to light. It is a physical and chemical phenomenon.

The PV effect has been used in order to generate electricity from sunlight. For example, PV solar panels absorb sunlight or light energy or photons, and generate electricity through the PV effect.

### SUMMARY

Some embodiments provide conjunction and connection methods, for inter-connecting or joining or conjoining or combining two or more co-located or neighboring or bordering solar panels or PV devices; and/or for connecting between one or more solar panels (or PV devices, or a joined solar module) and one or more other objects or infrastructure elements (e.g., a wall, a fence, a roof, a vehicle, a house, a floor, a pole).

Some embodiments provide a conjoined solar module, and a joining unit for conjoining multiple solar panels. For example, a joining unit has two back-to-back elongated rails. The first elongated rail has an elongated hollow cavity, and receives therein a set of beads or mushroom-shaped protrusions or lollipop-shaped protrusions that are connected to an edge of a first solar panel. Similarly, the second elongated rail has an elongated hollow cavity, and receives therein a set of beads or mushroom-shaped protrusions or lollipop-shaped protrusions that are connected to an edge of a second solar panel. Optionally, the joining unit has an additional elongated rail that defines an elongated cavity for storing metal wires that transport electricity generated by the solar panels. Optionally, each solar panel is flexible or rollable.

Some embodiments may enable to form, to deploy, to assemble and/or to disassemble a multi-panel solar module, from a plurality of discrete solar panels or solar cells; by using Joining Unit(s) that mechanically join or connect two (or more) solar panels to each other. Some embodiments may enable enabling and/or rapid connection and/or disconnection (or deployment, installation, removal, replacement) of flexible and rollable solar panels or solar modules.

Some embodiments may provide other and/or additional benefits and/or advantages.

### BRIEF DESCRIPTION OF THE DRAWINGS

FIG. 1A is a schematic illustration of a side-view of an elongated Joining Unit, which may be used for joining or conjoining or mechanically connecting two (or more) solar panels, in accordance with some demonstrative embodiments.

FIG. 1B is a schematic illustration of a solar panel having an edge with protrusions or slidable beads, in accordance with some demonstrative embodiments.

FIG. 1C is another schematic illustration of that solar panel having an edge with protrusions or slidable beads, in accordance with some demonstrative embodiments.

FIG. 1D is a schematic illustration of a Joining Unit having two rails implemented as directly touching each other back-to-back, in accordance with some demonstrative embodiments.

FIG. 1E is a schematic illustration of a Joining Unit having two rails of different sizes, in accordance with some demonstrative embodiments.

FIG. 1F is a schematic illustration of a Joining Unit having two rails of different shapes or structures, in accordance with some demonstrative embodiments.

FIG. 1G is a schematic illustration of a Joining Unit, configured to conjoin a solar panel with an infrastructure element or object, in accordance with some demonstrative embodiments.

FIG. 1H is a schematic illustration of a solar panel having an edge with protrusions that are held or mounted on short rods or pins, in accordance with some demonstrative embodiments.

FIG. 2A is a schematic illustration of a Joining Unit holding therein a solar panel, via protrusions of an edge of the solar panel that were inserted or slid into a corresponding elongated hollow cavity of a rail of the Joining Unit, in accordance with some demonstrative embodiments.

FIG. 2B is a schematic illustration of a Joining Unit holding therein and conjoining two solar panels, via protrusions of two respective edges of the two solar panels that were inserted or slid into two corresponding elongated hollow cavities of two corresponding rails of the Joining Unit, in accordance with some demonstrative embodiments.

FIG. 2C is a schematic illustration of a Joining Unit holding therein a solar panel, via protrusions of an edge of the solar panel that were inserted or slid into a corresponding elongated hollow cavity of a rail of the Joining Unit, in accordance with some demonstrative embodiments.

FIG. 2D is a schematic illustration of a Joining Unit holding therein a solar panel, and further demonstrating a stopper or blocker element that covers or at least partially blocks an opening of elongated hollow cavity of a rail of the Joining Unit, in accordance with some demonstrative embodiments.

FIG. 3A and FIG. 3B are schematic illustrations of a solar panel having an edge with different types of protrusions, in accordance with some demonstrative embodiments.

FIG. 4A is a schematic illustration of a conjoined solar module formed of two solar panels, in accordance with some demonstrative embodiments.

FIG. 4B is a schematic illustration of a conjoined solar module, formed of four solar panels and optionally connected to an infrastructure element or object, in accordance with some demonstrative embodiments.

FIG. 4C is a schematic illustration of a conjoined solar module, formed of several differently-sized and differently-shaped solar panels, in accordance with some demonstrative embodiments.

FIG. 5A and FIG. 5B are pictures of a portion of a flexible solar panel, having at its edge a flexible strip with protrusions or slidable beads for connecting the solar panel with a Joining Unit, in accordance with some demonstrative embodiments.

### DETAILED DESCRIPTION OF SOME DEMONSTRATIVE EMBODIMENTS

The Applicants have realized that some conventional solar panels are typically rigid, heavy, cumbersome, brittle and/or fragile units, that are typically installed on roofs or in other locations (e.g., a solar energy park, a solar energy farm, a solar power plant).

The Applicants have realized that transportation, installation, removal and/or replacement of such conventional solar panels can be costly, efforts consuming, time consuming; and often requires a professional technician to install fixed mounting units or other mechanical support units that hold the solar panel or otherwise support it.

The Applicants have realized that some solar panels are flexible and rollable; and there is a need to enable rapid, efficient, reduced-cost and reduced-effort solutions for transportation, installation, deployment, removal, and/or replacement of such flexible and rollable solar panels.

The Applicants have realized that it may be beneficial to efficiently join or conjoin, or to efficiently deploy in a co-located or bordering manner, two or more flexible solar panels; to form a conjoined solar module or PV device, or to form a joined or multi-panel solar module or PV device, or to efficiently cover with solar panels an area that is greater than the area of a single solar panel.

The Applicants have realized that there is a need for a solar panel Joining Accessory or a Conjoining Accessory, which may be utilized as a stand-alone or autonomous accessory, or which may (optionally) be an integral part of a flexible solar panel; and which may enable the efficient and/or rapid joining or conjoining of solar panels, and/or the efficient and/or rapid deployment or installation or mechanical placement or mechanical connection or mechanical mounting of a single solar panel or of multiple solar panel.

The Applicants have realized that there is a need for a solar panel Joining Accessory or a Conjoining Accessory, which may be utilized to efficiently and/or rapidly establish a mechanical connection or a mechanical mounting, of (I) a flexible solar panel (or a flexible solar module which comprises a plurality of co-located or bordering or neighboring solar panels), with (II) a nearby object or infrastructure element (e.g., a wall, a fence, a roof, a vehicle, a floor, a pole, or the like).

The Applicants have realized that there is a need for solar panel Joining Accessory or a Conjoining Accessory, that may also enable efficient and rapid and selective removal of a particular solar panel, or of a particular solar module, or of a particular set or subset or group of solar panels; in order to enable replacement of a defective or malfunctioning solar panel, or in order to enable cleaning or maintenance of a solar panel, or in order to enable the efficient relocation of a solar panel (or solar module) from a first location to a second location.

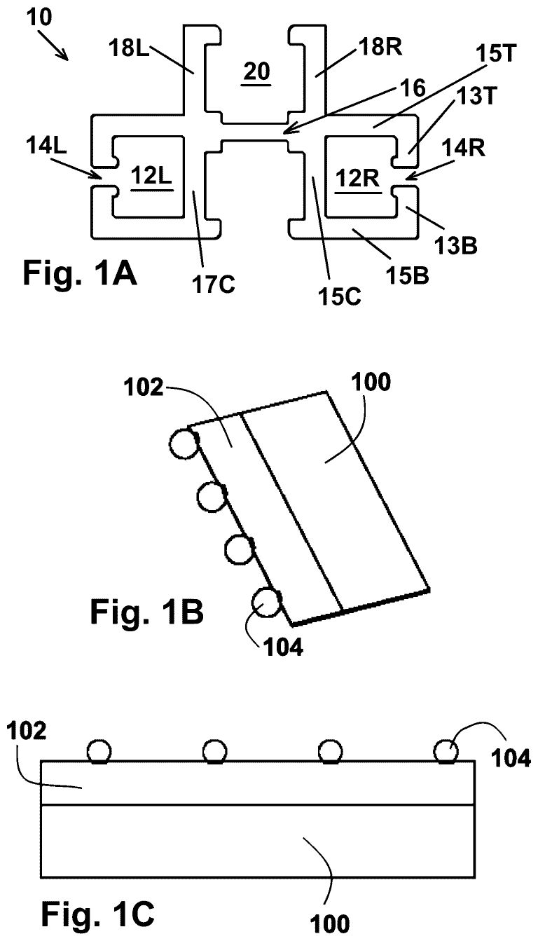

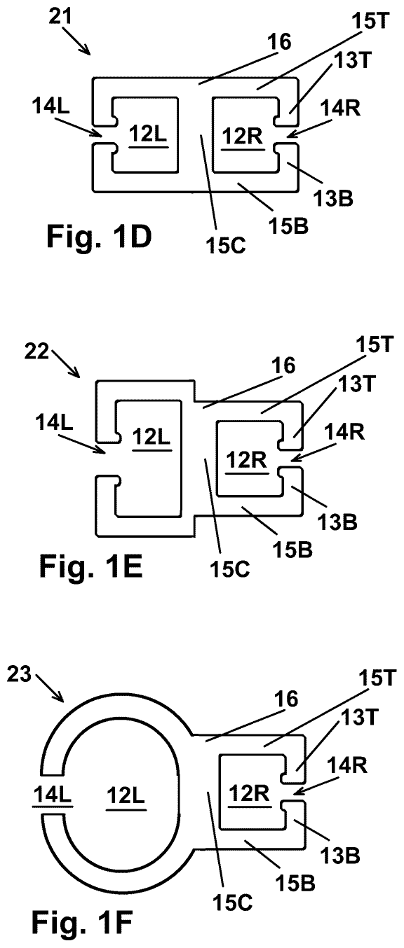

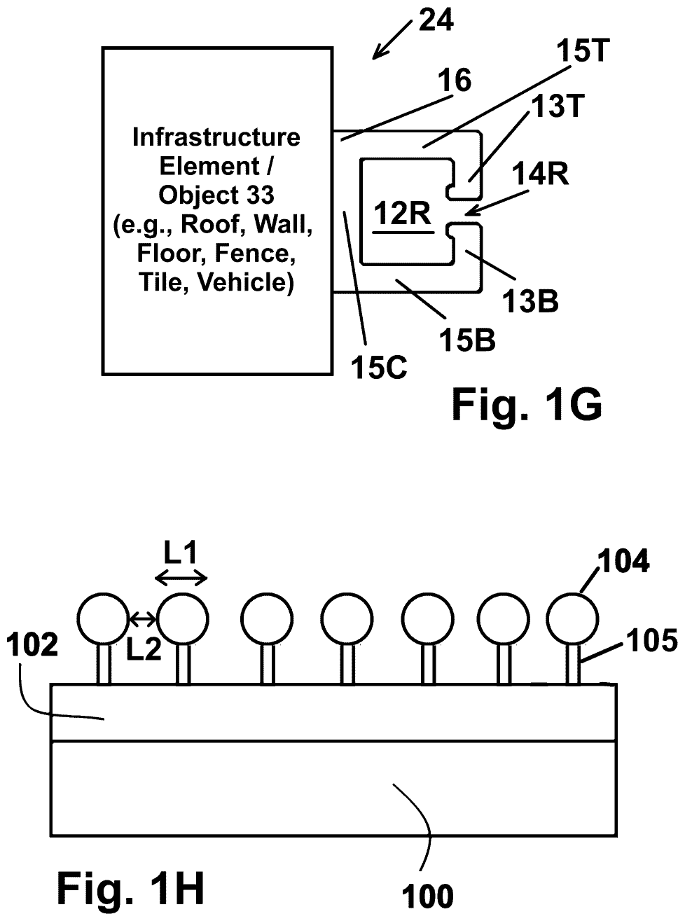

Reference is made to FIG. 1A, which is a schematic illustration of a side-view of an elongated Joining Unit 10 which may be used for joining or conjoining or mechanically connecting two (or more) solar panels, in accordance with some demonstrative embodiments; or which may be utilized as a conjunction unit or a conjunction profile for mechanically joining two or more solar panels.

For example, the elongated Joining Unit 10 may be implemented as an elongated conjunction profile, having two generally-opposite, elongated, partially-open, hollow rails; denoted as right-side rail 12R and left-side rail 12L. Each one of the rails (12R and 12L) has a narrow opening (14R and 14L, respectively), which runs along the elongated rail; for example, defined by two tooth-shape elongated protrusions. For example, observing the right-side rail 12R, its cavity is defined by: an elongated central rail 12C; connected generally-perpendicularly at its top side to a top rail 15T, and connected generally-perpendicularly at its bottom side to a bottom rail 15B; which in turn are further connected, generally perpendicularly, to a top-side tooth 13T and to a bottom-side tooth 13B; thereby defining the hollow cavity of the right-side rail 12R, with a narrow right-side opening 14R defined by the two tooth-shaped rails 13T and 13B. Similarly, the left-side rail 12L has a hollow cavity, defined by similar rails (central, top, bottom) and similar tooth-shaped rails, and further defining a narrow left-side opening 14L.

A joiner element 16, implemented as an elongated rail or panel, mechanically joins or connects or bridges the two rails 12R and 12L. In some embodiments, optionally, the joiner element 16 may be short, such that the left-side rail 12L and the right-side rail 12R may directly touch or may directly connect to each other as a back-to-back coupled structure; such that the central panel of each rail (e.g., panel 15C of the right-side rail 12R, and a corresponding central panel 17C of the left-side rail 12L) are placed directly back-to-back, or such that their central panels (15C and 17C) are a single, unified, panel that is common to both of the rails (12R and 12L).

Reference is made to FIG. 1D, which is a schematic illustration of a Joining Unit 21, in accordance with some demonstrative embodiments; which may be generally similar to Joining Unit 10 described above, but having the two rails (12R and 12L) implemented as directly touching each other back-to-back, without a joiner element that separates them and without a top-side channel for wires (or for other purposes); thereby enabling direct and small form-factor conjoining or joining of two solar panels (or, a solar panel and another object or infrastructure element).

Optionally, joiner element 16 may be implemented as a U-shaped rail, or as an elongated channel defined by two elongated panels (18R and 18L), which may optionally end with two inwardly-facing teeth element, to thereby define a channel 20 having a hollow, elongated, cavity; which may be used to hold or to store or to protect therein electric cables or metal wires or electricity-transporting elements.

For demonstrative purposes and as a non-limiting example, a right-side rail 12R and a left-side rail 12L are shown; however, the elongated Joining Unit 10 may be implemented to have only a single rail (e.g., only 12L or only 12R) such that its other side may be attached to an infrastructure element or other object; or, the elongated Joining Unit 10 may have two such rails (e.g., similar to 12L and 12R) which may not be opposite to each other, or which may not be at 180 degrees relative to each other; but rather, may be perpendicular to each other, or may be at a particular angle to each other; or, the elongated Joining Unit 10 may have three such rails or four such rails (e.g., generally perpendicular to each other), or other suitable number and/or arrangement of such rail(s).

For demonstrative purposes and as a non-limiting example, each one of the rails (12L and 12R) is shown as a generally U-shaped or C-shaped elongated rail or elongated channel, or as a having a generally square-shaped or rectangular cross-section; however, in other embodiments, other suitable structures or shapes may be used.

In some embodiments, optionally, a single elongated Joining Unit 10 may have may have two (or more) different types or different shapes or different sizes of rails; such that, for example, right-side rail 12R may be as shown, whereas left-side rail 12L may be larger in size (e.g., 25 or 50 percent larger) and/or may have other shape (e.g., may have a cross-section that is similar to a curved C letter, rather than an almost-square cross section); thereby enabling a single elongated Joining Unit 10 to be utilized for modularly connecting or conjoining or joining two (or more) solar panels of different types or of different models or of different manufacturers.

Reference is made to FIG. 1E, which is a schematic illustration of a Joining Unit 22, in accordance with some demonstrative embodiments; which may be generally similar to Joining Unit 10 described above, but having the two rails (12R and 12L) implemented as directly touching each other back-to-back, without a joiner element that separates them and without a top-side channel for wires (or for other purposes); and having different sizes; thereby enabling connection or conjoining of two solar panels from two different models or manufacturers, or twos solar panels having different sizes of connection beads or connection protrusions.

Reference is made to FIG. 1F, which is a schematic illustration of a Joining Unit 23, in accordance with some demonstrative embodiments; which may be generally similar to Joining Unit 10 described above, but having the two rails (12R and 12L) implemented as directly touching each other back-to-back, without a joiner element that separates them and without a top-side channel for wires (or for other purposes); and having different shapes or structures; for example, rail 12R being generally square-shaped, and rail 12L being generally shaped as a curved C letter; thereby enabling connection or conjoining of two solar panels from two different models or manufacturers, or twos solar panels having different sizes of connection beads or connection protrusions.

The elongated Joining Unit (10, 21, 22, 23, or other implementations thereof) and its components may be formed, for example, of aluminum, iron, steel, copper, an alloy of aluminum and other metal(s), an alloy of metals, or other suitable materials; and particularly, of one or more materials that can withstand and endure long-term exposure to high temperatures, since solar panels (and the elongated Joining Unit 10 that joins them or that connects them) are typically intended to be placed at a sunny outdoor location that has direct or indirect exposure to sunlight and possibly heat. In other embodiments, optionally, the elongated Joining Unit 10, or at least some of its components, may be formed of plastic material(s) or other suitable materials; for example, if the solar panel is intended to be deployed in an indoor environment, or in an environment that has exposure to sunlight yet typically does not reach high temperature.

Reference is made to FIG. 1G, which is a schematic illustration of a Joining Unit 24, in accordance with some demonstrative embodiments; configured to conjoin a solar panel with an infrastructure element or an object 33 (for example, a roof, a roof shingle, a tile, a floor, a floor tile, a wall, a fence, a vehicle, a vehicular component, a pole, or the like). In some embodiments, a single rail 12R is directly and integrally connected to the infrastructure element/object 33, or is an integral part of such infrastructure element/object 33; for example, a fence or a fence-panel or a wall may be formed to have such rail 12R protruding at (or located at) an edge or border thereof. In other embodiments, region 15C of the Joining Unit 24 may comprise an adhesive layer or adhesive tape or bonding agent or glue, enabling to adhere or bond or glue the rail 12R to the infrastructure element/object 33. In other embodiments, the rail 12R may be connected via other means to the infrastructure element/object 33; for example, with screws, with nails, or the like. Joining Unit 24 may enable efficient and rapid deployment of a solar panel that is intended for placement or mounting at or near such infrastructure element/object 33, or that is intended to touch or be co-located with such infrastructure element/object 33.

Reference is made to FIG. 1B and FIG. 1C, which are schematic illustrations of a solar panel 100 (e.g., which may optionally be flexible and/or rollable) having an edge 102 with protrusions 104 (e.g., beads or other type of protrusions), in accordance with some demonstrative embodiments. In some embodiments, exactly one edge of solar panel 100 (e.g., out of four edges of a generally-rectangular solar panel) has the protrusions 104, in order to enable one-side connection or conjoining of that solar panel to one additional solar panel (or to an infrastructure element or object). In other embodiments, exactly two edges of solar panel 100 (e.g., out of four edges of a generally-rectangular solar panel) have the protrusions 104, in order to enable two-side connections or conjoining of that solar panel to two additional solar panels (or to other infrastructure elements or objects); and such two edges may be opposite edges (e.g., to enable connection of the solar panel 100 to one other solar panel via its left edge and to one other solar panel via its right edge), or may be two neighboring and perpendicular edges of the solar panel (e.g., to enable connection of the solar panel 100 to one other solar panel via its left edge and to one additional solar panel via its top edge). In other embodiments, three edges or all four edges of solar panel 100 have such protrusions 104, in order to enable modular and/or selective connection of solar panel 100 to one or more other solar panels or objects or infrastructure elements, to enable enhanced modularity and efficient deployment.

Protrusions 104 are a row or a line or a set of neighboring, spaced-apart, beads or sphere-shaped protrusions or egg-shaped protrusions or cube-shaped protrusions (or protrusions or beads having other shapes or structures), or protrusions that are shaped generally like a lollipop or like a mushroom (e.g., having a base rod and then a larger/thicker/wider cap region or semi-spherical region); which can be slid or inserted or pushed into an elongated cavity of a rail of a Joining Unit (10, 21, 22, 23, or other Joining Unit), to thereby cause the solar panel 100 to be mechanically and physically connected to the Joining Unit and to any other solar panel(s) or object(s) or infrastructure element(s) that are on the opposite side and/or the other side(s) of such Joining Unit.

In accordance with some embodiments, the set or row of spaced-apart protrusions (e.g., slidable beads or sliding beads, or other protrusions) runs along the entirety of the length of the edge of the solar panel to which that set is attached. In other embodiments, the set or row of spaced-apart protrusions (e.g., slidable beads or sliding beads, or other protrusions) runs along approximately 95 or 90 or 85 or 80 or 75 percent of the entirety of the length of the edge of the solar panel to which that set is attached; such that at least the central 75% of the edge of the solar panel has protrusions adjacent to it; in such implementations, the entirety of the length of the edge may be inserted into the elongated hollow cavity of the respective rail (e.g., rail 12R or 12L), and the protrusion that occupy at least 75% of the length of the edge may suffice to hold in place the entirety of that edge of that solar panel; and such implementation may optionally be used in order to reduce the weight and/or the production cost of the solar panel.

For example, protrusions 104 are configured to be inserted into the elongated hollow cavity or channel that is within the corresponding rail (e.g., 12R or 12L) of the Joining Unit; and two (or more) solar panels can be threaded within two (or more) such rails, so that the solar panels become mechanically inter-connected or conjoined, thereby creating a conjoined solar module of two (or more) co-located solar panels.

In some embodiments, each protrusion 104 is a sphere or a bead or other suitable protrusion that is directly connected to the edge 102 of the solar panel. In other embodiments, optionally, a protrusion 104 may be connected to the edge 102 via a small-size or short-length rod or pin 105, similar to a spherical lollipop on a stick or similar to a mushroom; in order to enable slight distancing of the protrusion itself from the edge 102 of solar panel 104, to thereby accommodate a rail having a particular structure of locking teeth or edges. Reference is made to FIG. 1H, which is a schematic illustration of solar panel 100 having an edge 102 with such protrusions 104 that are held or mounted on short rods or pins 105, in accordance with some embodiments.

In some embodiments, the diameter of each protrusion or bead, or the maximum width of each protrusion or bead, is denoted as L1; and the spaced-apart distance between a pair of neighboring protrusions is denoted as L2. In some embodiments, L2 is smaller than L1; or, in some embodiments, L2 is smaller than or equal to L1. In some embodiments, L2 is between 0.25 times L1 to L1. In some embodiments, L2 is between 0.25 times L1 to two times L2. In some embodiments, L2 is between 0.5 times L1 to three times L2. In some embodiments, optionally, the distance L2 between neighboring protrusions may be increased (e.g., to be two or three or four or five times L2), in order to reduce production costs and/or in order to reduce the total weight of the solar panel; as even spaced-apart protrusions may suffice for holding in place the solar panel and its edge. In some embodiments, the ratio of L2 to L1 is configured or pre-defined, in order to enable smooth and efficient sliding or insertion of consecutive protrusions or beads into the rail or channel that holds them. The above-mentioned distances L1 and L2, and their ratios, may be implemented in any implementation of the protrusions 104, including the implementations shown in FIG. 1H or in FIG. 1C or other suitable implementations, with the rods/pins 105 or without them.

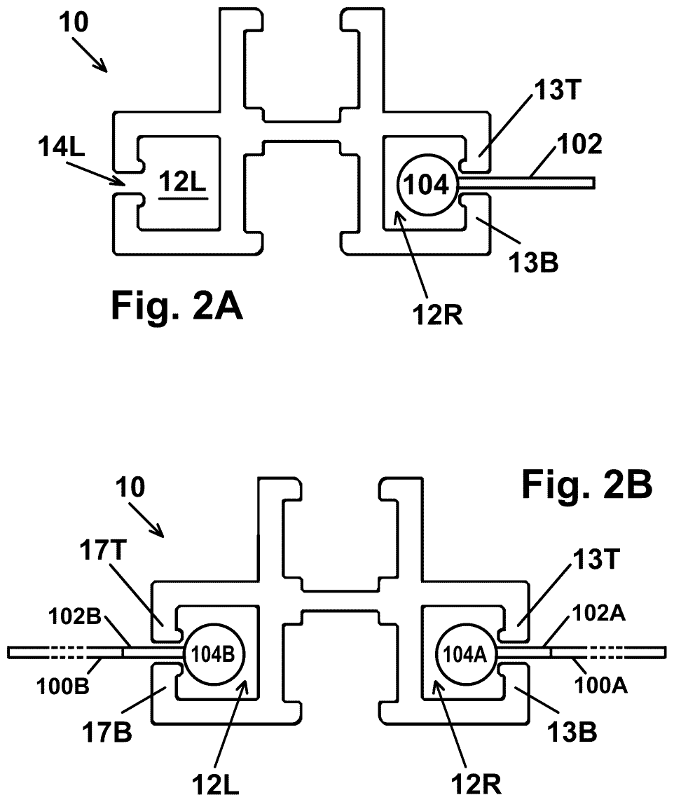

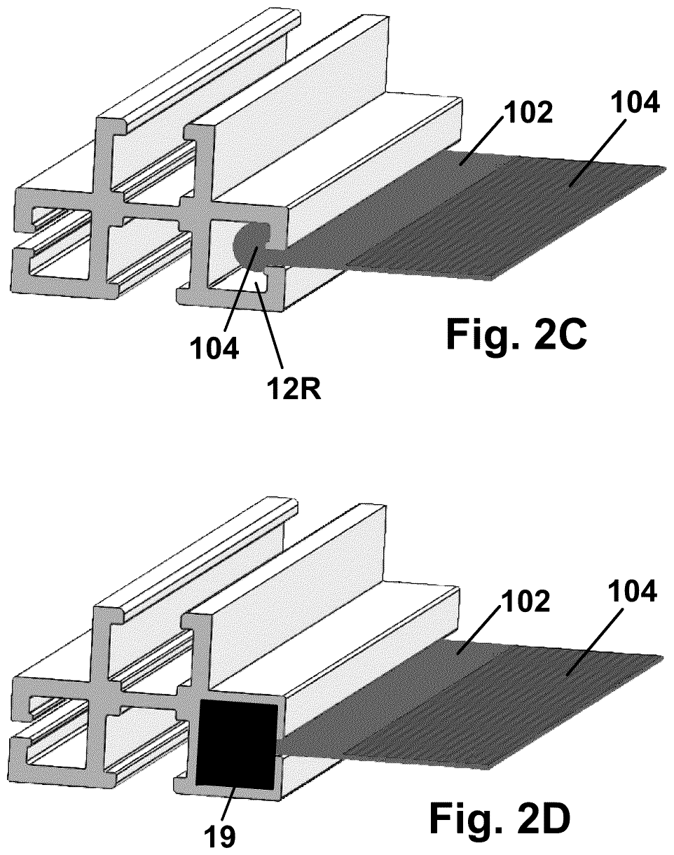

Reference is made to FIG. 2A and FIG. 2C, which are schematic illustrations of an edge 102 of a solar panel 100, having protrusions 104 that were inserted or slid or threaded into the corresponding elongated cavity or elongated hollow tube of rail 12R of Joining Unit 10, in accordance with some demonstrative embodiments. The protrusions 104 are enclosed and trapped (or confined, or constrained) within the hollow tube or the hollow channel of the rail, and the teeth (13T and 13B) of the rail prevent the protrusions 104 from being pulled-away or from falling-out from the hollow cavity or tube. The protrusions 104 (e.g., a row of sliding beads) are threaded or inserted into the hollow tube of the rail, and the edge 102 connects those protrusions 104 to the solar panel. In some embodiments, a portion of the edge 102 itself is also within the teeth (13T and 13B) of the rail; or, in other embodiments, pins/rods may protrude from the edge in order to hold each protrusion 104, and such pins/rods are partially within the hollow tube with the protrusions that they hold. The size or volume of each protrusion 104, is slightly smaller than the size or volume of the corresponding cavity of the rail; for example, being 90 or 80 or 70 percent of the size or volume of such cavity; yet, the size or volume or shape of the protrusion 104 is also preventing it from falling-out through the gap that is between the teeth 13T and 13B.

Reference is made to FIG. 2D, which is a schematic illustration of edge 102 of solar panel 100, having protrusions 104 that were inserted into the corresponding elongated cavity or rail 12R of Joining Unit 10, and also demonstrating a Stopper/Blocker element 19 in accordance with some demonstrative embodiments. For example, in some embodiments, optionally, a Stopper 19 or a Blocker or a Stopping/Blocking Element or Stopping/Blocking Panel may be implemented at an edge or an ending of the rail 12R, in order to stop or block the set of protrusions 104 from sliding out of an ending of the elongated hollow tube or the elongated hollow cavity of the rail 12R. For example, a thin metal panel or a thin plastic panel operating as a first Stopper 19 may be adhered or glued or bonded or otherwise attached at one ending of at one opening of the rail 12R, prior to (or after) the insertion of the protrusions 104; and optionally, another Stopper 19 may be attached to the other ending or opening of rail 12R, after the insertion of the protrusions 104 into the elongated hollow tube of rail 12R, in order to trap (or confine, or constrain) and hold the protrusions 104 within the elongated hollow tube and to prevent them from spilling-out or sliding-out, from one ending or from any of the two endings of the elongated hollow tube of rail 12R. In some embodiments, optionally, Stopper 19 may be implemented as a cover or a lid, which may be selectively placed onto, and optionally removed from, the ending or the opening of the elongated hollow tube of the rail 12R.

Reference is made to FIG. 2B, which is a schematic illustration of double-sided or dual-side Joining Unit 10, holding and conjoining two solar panels 100A and 100B, in accordance with some demonstrative embodiments. Edge 102A of solar panel 100A has protrusions 104A that were inserted into the elongated hollow cavity of the right-side rail 12R; and teeth 13T and 13B (or similar lips, or inwardly-curved edges) of rail 12R trap (or confine, or constrain) therein those protrusions 104A, while the edge 102A (which is thinner than the protrusions 104A) is in the gap between teeth 13T and 13B. Similarly, edge 102B of solar panel 100B has protrusions 104B that were inserted into the elongated hollow cavity of the left-side rail 12L; and teeth 17T and 17B (or similar lips, or inwardly-curved edges) of rail 12L trap (or confine, or constrain) therein those protrusions 104B, while the edge 102B (which is thinner than the protrusions 104B) is in the gap between teeth 17T and 17B.

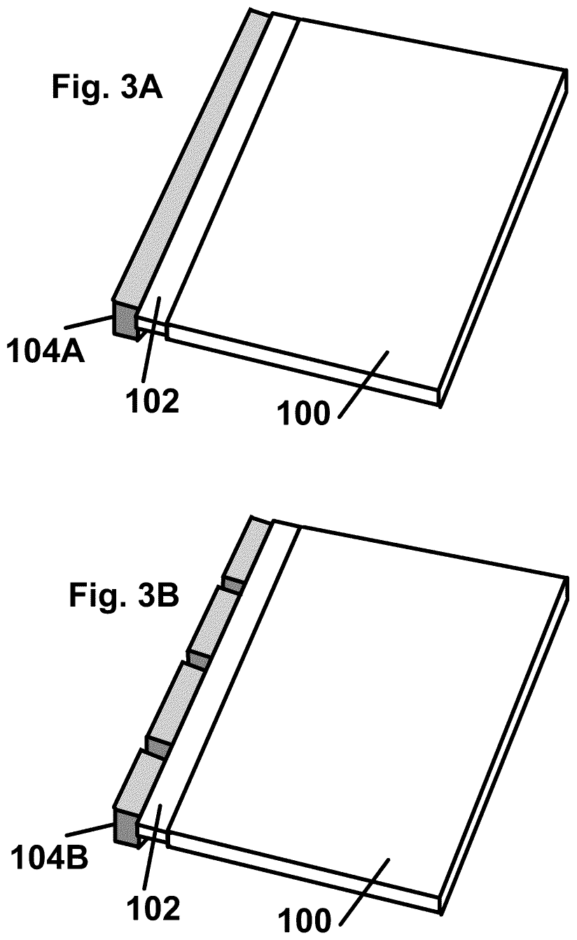

Reference is made to FIG. 3A and FIG. 3B, which are schematic illustrations of a solar panel 100 having an edge 102 with different types of protrusions, in accordance with some demonstrative embodiments.

As demonstrated in FIG. 3A, the protrusions are implemented as (or, are replaced by) a single elongated beam 104A, shown as having a square or rectangular cross-section, but optionally having other suitable cross-section (e.g., a circular cross-section, such that elongated beam 104A is an elongated cylinder). The entirety of the elongated beam 104A protrudes relative to the edge 102, and is thicker or larger than the height of edge 102, to allow sliding of the elongated beam 104A into a corresponding hollow tube or hollow cavity of a rail (e.g. of rail 12R discussed above).

As demonstrated in FIG. 3B, the protrusions are implemented as (or, are replaced by) a set of several elongated, spaced-apart, beam-segments 104B, shown as having a square or rectangular cross-section, but optionally having other suitable cross-section (e.g., a circular cross-section, such that element 104B is a set of consecutive spaced-apart cylinders). The beam-segments 104B protrude relative to the edge 102, and are thicker or larger than the height of edge 102, to allow sliding of the beam-segments 104B into a corresponding hollow tube or hollow cavity of a rail (e.g. of rail 12R discussed above).

In some embodiments, the elongated beam-shaped protrusion 104A, or the set of beam-segment protrusions 104B, may be formed of metal or other rigid material; or may be formed of rigid plastic, or other suitable rigid materials. In other embodiments, the elongated beam-shaped protrusion 104A, or the set of beam-segment protrusions 104B, may be formed of a flexible and/or rollable material (e.g., flexible plastic, rubber, or other materials), to allow rolling and/or folding and/or flexing of the entirety of the solar panel 100 with its edge 102 and with its protrusion elements 104A/104B.

Referring now to the various type of protrusions elements, such as the spherical beads 104 of FIG. 1C, or such as the elongated beam 104A or the beam-segments 104B, it is noted that the maximum thickness or the largest dimension or the largest diameter of such protrusion(s) should be: (i) greater or thicker than the thickness of the edge 102 of the solar panel 100, to ensure that the protrusion itself goes through the elongated hollow cavity of the rail 12R while the thinner edge 102 passes through the nearby gap 14R between the trapping (or confining, or constraining) teeth 13T and 13B; and also (ii) smaller than the size of the elongated hollow cavity of rail 12R, to ensure that the protrusion can indeed be inserted into the elongated hollow cavity of rail 12R; and also (iii) greater than the size of the gap 14R between the trapping teeth 13T and 13B, to ensure that the protrusion cannot exit from the rail 12R “sideways” through that gap between trapping teeth 13T and 13B.

In some embodiments, edge 102 is a smooth continuation of solar panel 100, such that edge 102 (or at least some regions thereof) is capable of generated electricity from light via the photovoltaic effect; in order to reduce the burden of producing an additional edge component that is not a PV-cell by itself. In other embodiments, edge 102 need not be a PV cell by itself, and does not have the capability to convert light into electricity via the PV effect; rather, edge 102 may be implemented as an extension or continuation of flexible plastic material or metal, which may extend beneath and protrude outwardly from the solar panel 100, as an edge or a bordering region whose purpose is only to mechanically connect the solar panel 100 to another solar panel or to an infrastructure element/object via the rail 12R of the relevant Joining Unit.

Some embodiments provide a method and accessories for connecting or joining or conjoining together two or more solar panels, to form a conjoined solar module; or to cover an area that is larger than the area of a single solar panel; or for connecting a solar panel (or a conjoined solar module) to an infrastructure element or object. For example, a Joining Unit is produced and provided; a first solar panel is connected to a first rail of the Joining Unit, by inserting or sliding the protrusion(s) into the elongated hollow cavity of the rail, and pushing or sliding forward the solar panel along that edge. Optionally, a distal stopper or blocker element is utilized to cover or to block the distal opening of the rail, prior to the insertion or after the insertion. Optionally, a proximal stopper or blocker element is utilized to cover or to block the proximal opening of the rail, after the insertion, in order to fully capture or trap or confine or constrain the protrusion(s) within the elongated hollow cavity of the rail. Optionally, another solar panel is similarly connected to another rail of the same Joining Unit. Optionally, an infrastructure element or object (e.g., a roof tile, a fence panel, a wall, a pole, a vehicular component) is connected to another rail of the same Joining Unit. Optionally, no other solar panel or object are connected to any other rail of the Joining Unit; but rather, the Joining Unit is already an integral component of such other object or infrastructure element; or, the Joining Unit is non-removably attached (or, is removably attached) to such other object or infrastructure element. Optionally, the solar panel may be slid-out or pulled-out or disconnected from the Joining Unit; for example, by removing a stopper/blocker element (if utilized), and then sliding out or pulling out the solar panel by moving it along the longest dimension of the Joining Unit, to slide out the protrusion(s) from within the elongated hollow cavity of the rail. Optionally, a solar panel may be maintained or repaired or cleaned, and then inserted back or slid-back into the rail; or, a solar panel may be replaced with a new one which may be slid into the rail.

Some embodiments may enable efficient transportation, storage and/or deployment of a solar module. For example, a target location may require a solar module having a size of approximately 10 by 7 meters. Eighty solar panels are produced, each solar panel being approximately 1 by 1 meter. The eighty solar panels may be piled or stacked, or optionally are rolled or folded together (if they are flexible and/or rollable), and may thus be transported in a small-size box (e.g., a box or a container having an area of 1.1 by 1.1 meters, and having a height that can accommodate the stack or pile of 80 solar panels, which may be thin, such as less than 1 centimeter thickness per solar panel). Additionally, sixty-three (63) Joining Units are produced and transported; each one of them being similar to Joining Unit 10; each one of them being an elongated member, having a length of approximately 1 meter. The stack of such 63 joining units may be transported, in the same truck or vehicle, or in a nearby box, to the location intended for deployment. There, the 70 solar panels are placed on the ground, to form an array or matrix of 10 by 7 solar panels, having 10 rows and 7 columns. In each of the 10 rows, there are 7 solar panels next to each other; and each pair of solar panels is joined by one Joining Unit; such that 6 joining units are utilized to join together a row of 7 solar panels. There are 10 rows, and 6 joining units are utilized per row, such that 10×6=60 joining units are utilized to form the 10 rows. Then, each row of 7 solar panels, is connected to a neighboring row of 7 solar panels; by using 7 joining units that are perpendicular to the longest dimension of each row. Since there are 10 rows, they are connected by using 9×7=63 joining units. In total, 60+63=123 joining units are used, to create the matrix of 10 by 7 solar panels.

The above is a non-limiting example; and sizes and numbers of solar panels may vary, as well as the shape or area that is intended to be covered. In some embodiments, solar panels may be conjoined to form a structure that is non-symmetrical and/or non-rectangular, in order to cover a particularly-shaped area or in order to fit over a particularly-shaped roof or structure.

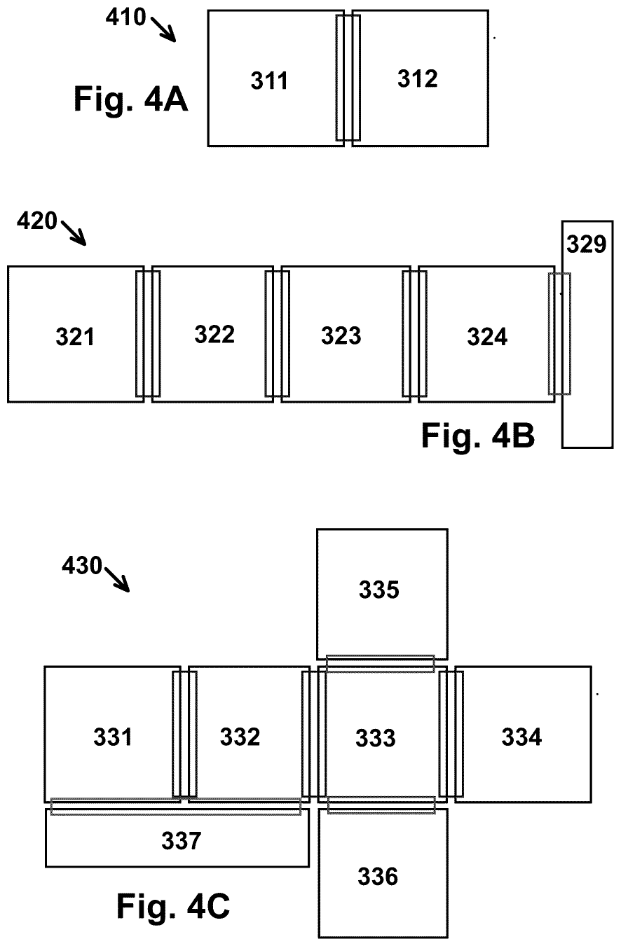

Reference is made to FIG. 4A, which is a schematic illustration of a conjoined solar module 410, in accordance with some demonstrative embodiments. Two solar panels 311-312 are conjoined via a single double-sided Joining Unit, similar to Joining Unit 10 described above.

Reference is made to FIG. 4B, which is a schematic illustration of a conjoined solar module 420, in accordance with some demonstrative embodiments. Four solar panels 321-324 are conjoined via a three double-sided Joining Units, each joining unit being similar to Joining Unit 10 described above. Additionally, the set of four conjoined solar panels is further connected, via another Joining Unit, to an infrastructure element/object 329.

Reference is made to FIG. 4C, which is a schematic illustration of a conjoined solar module 430, in accordance with some demonstrative embodiments. Seven solar panels 331-337 are conjoined via six different double-sided Joining Units, each joining unit being generally similar to Joining Unit 10 described above. As demonstrated in FIG. 4C, the conjoined solar module 430 is non-symmetrical; and includes solar panel 337 that has larger width and shorter height relative to the other solar panels 331-336. As also demonstrated, it is possible that one solar panel 337, would be connected to two (or more) solar panels 331-332, in a consecutive manner, along the same edge of that one solar panel 337, via two (or more) consecutive Joining Units. Other suitable structures or combinations may be formed.

In some embodiments, optionally, a solar panel may be manufactured or produced without yet having the set of protrusions; and a strap or strips of fabric (e.g., woven or knitted fabric, formed of polyester and/or other yarns) or plastic or metal, or polymeric film or sheet, or rubber film or sheet, or other suitable material, may then be attached to (or at, or beneath, or above) an edge or a border or a margin region of the solar panel, via gluing or bonding or by using adhesive tape or other connection methods; and this, in turn, converts or upgrades or modifies such solar panel to be compatible with joining/conjoining via the Joining Unit(s) described above. In some embodiments, the production of the flexible strap or strip of protrusions, and/or the attachment of such flexible strap or strip of protrusions to (or within, or beneath) the solar cell, may be an integral step in the production process of the solar cell; such that the solar cell is produced as a solar cell that immediately has a built-in or integrated flexible strap or strip of protrusions.

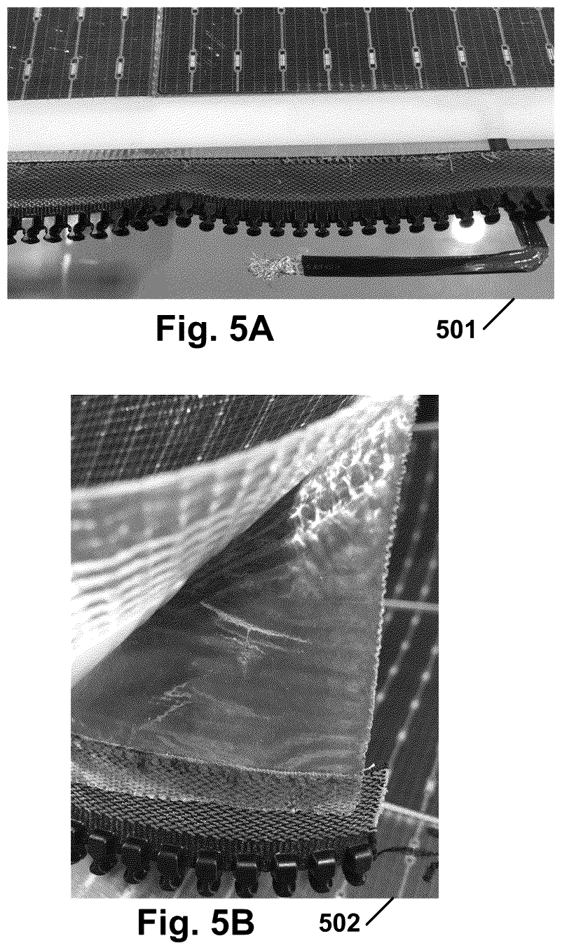

Reference is made to FIG. 5A and FIG. 5B, which are pictures (501 and 502) of a portion of a flexible solar panel, having at its edge a flexible strip or flexible strap with protrusions (e.g., beads) for connecting the solar panel with a Joining Unit, in accordance with some demonstrative embodiments.

As demonstrated in FIG. 5A, the solar cell has an edge or a border to which a set or line of protrusion beads are connected, optionally through a flexible strap. The solar cell has electrical connections, and utilizes metal wires or other mechanisms to collect, aggregate and/or transport the PV-generated electricity. In some embodiments, the flexible strap is formed of a material that can be connected to an edge or a border of a solar cell using a suitable connection method, for example, heat, heat-press, lamination, adhesive, gluing, bonding, curing, radiation, sowing, welding, or a combination of two or more connection methods.

As demonstrated in FIG. 5B, the flexible strap with the row of protrusion beads is connected to one of the layers that supports the solar cell, or to one of the layers that is laminated to (or beneath) the solar cell or the electricity-generating regions of the solar cell. In some embodiments, the flexible strap is attached to (or, is attached beneath) the lowest layer of the solar cell itself. In other embodiments, the flexible strap is attached to (or, is attached beneath) the lowest support layer or the lowest support structure, that supports thereon the solar cell itself. In other embodiments, the flexible strap is attached as a sandwiched component between the solar cell itself (e.g., the components/layers that produce electricity from light) and a support layer or a support structure or a support substrate that carries the solar cell or that the solar cell is mounted thereon. In other embodiments, the flexible strap is attached as a sandwiched component between two layers of the solar cell itself (e.g., sandwiched between two of the layers of the PV device that produces electricity from light). In some embodiments, the flexible strap is laminated or welded to one or more layers of the solar cell, or to a back-sheet of the solar cell, or beneath the back-sheet of the solar cell, or immediately on top of the back-sheet of the solar cell.

Some embodiments provide a conjunction unit or a joining unit, having a profile with a holding rail having an elongated hollow cavity (or tube) that is configured to receive therein a set of protrusions of an edge of a solar panel. Optionally, a second holding rail is part of the same joining unit; for example, located opposite the first holding rail, or perpendicular to the first holding rail, or located back-to-back with (and directly touching) the first holding rail. Optionally, each rail has edges or lips or teeth that trap or hold the protrusions therein, as the protrusions (e.g., mushroom shaped or lollipop shaped, or slidable beads) are thicker than the gap between such teeth or lips, and as the protrusions are thicker than the edge of the solar panel (which is capable of being placed between such lips or teeth or edges). In some embodiments, a Joining Unit may be used to connect two (or more) solar panels, or, to connect one or more solar panel with one or more infrastructure elements/objects that are similarly equipped with a similar set of protrusions or slidable beads.

In some embodiments, the protrusions or the sliding beads or slidable beads are connected to at least one edge of a solar cell, such that the conjunction or the joining unit connects at least two solar cells to forms a conjoined solar panel.

In some embodiments, the protrusions or the sliding beads or slidable beads are connected to at least one edge of a solar panel, such that the conjunction or the joining unit connects at least two solar panels to forms a conjoined solar module.

In some embodiments, optionally, an edge of a solar panel has a first set of interlocking teeth of a zipper (or a zip fastener, or a clasp locker); and a Joining Unit has a second set of interlocking teeth of such zipper; and a movement of a Y-shaped slider in a first direction is used to interlock the teeth in order to close the zipper and thus connect the solar panel to the Joining Unit; and a movement of the Y-shaped slider in a second, opposite, direction is used to separate the interlocked teeth in order to open the zipper and thus disconnect the solar panel from the Joining Unit. In some embodiments, such zipper-component may be integrally attached or non-removably attached to an edge of a solar panel or a solar cell.

The innovative joining unit in accordance with some embodiment is innovative and may even be regarded as surprising or counter-intuitive; as conventional (prior art) system had utilized, for years, cumbersome and complex methods and units for mounting of solar panels; had used screws and nails and metal rods and metal support systems for mounting and co-locating heavy and fragile and non-flexible and non-rollable solar panels (e.g., on a roof, or in a field or farm of solar panels); had typically required a professional installer person with complex manual labor. In contrast, and innovatively and surprisingly, some embodiments provide a Joining Unit having an elongated hollow cavity or tunnel, into which a corresponding protrusion or set-of-protrusions of a flexible solar panel can be inserted; and further provide a flexible solar panel having such corresponding protrusion or set-of-protrusions that can slide into such elongated hollow cavity or tunnel of the Joining Unit; thereby providing an efficient, lightweight, small form-factor, small footprint, reduced-cost, joining or conjoining solution for two (or more) solar panels; and providing, in some embodiments, a nail-free and screw-free solution, or a welding-free solution, or a modular solution that enables to change or replace or add or remove a solar panel to (or from) a Joining Unit without using specific tools (e.g., without a screwdriver, without a drill, without a hammer, without screws/nails or nuts and bolts) and in a rapid an efficient manner. In some embodiments, this specific solution may be achieved since the solar panel is a flexible and/or rollable solar panel, which does not break when folded or rolled or curved or flexed, and which may be curved or rolled (slightly, or even significantly) in order to facilitate the sliding-in or the insertion of the elongated protrusion of the solar panel into the corresponding elongated hollow cavity (or tunnel) of the Joining Unit; although in some other embodiments, the Joining Unit may also be used with non-flexible or non-rollable or non-foldable solar panels, which still have similar protrusion or set-of-protrusions and can still slide-in and slide-out relative to the corresponding elongated hollow cavity (or tunnel) of the Joining Unit.

### Additional/Optional Features:

In some embodiments, a solar cell that is utilized in conjunction with the Joining Unit, may be an autonomously flexible and/or rollable and/of foldable solar cell, that does not break and does not brittle when flexed or curved or bent or folded or rolled, and that is resilient to mechanical forces, and that can autonomously absorb and/or dissipate and/or withstand mechanical forces and mechanical shocks; for example, by being segmented or grooved or trenched with non-transcending gaps or “blind gaps” or craters or grooves or trenches, that penetrate some—but not all—of the thickness (or the depth) of a silicon layer or a semiconductor body or a semiconductor wafer; and optionally by having filler material(s) in such grooves or trenches or non-transcending gaps or non-transcending craters, to further absorb and/or dissipate mechanical forces and shocks.

Optionally, some embodiments may be utilized in conjunction with PV devices and/or solar panels and/or components and/or methods that are described in U.S. Pat. No. 11,081,606, titled “Flexible and rollable photovoltaic cell having enhanced properties of mechanical impact absorption”, which is hereby incorporated by reference in its entirety; and/or in conjunction with components, structures, devices, methods, systems and/or techniques that are described in patent application number U.S. Ser. No. 17/353,867, filed on Jun. 22, 2021, published as US 2021/0313478, which is hereby incorporated by reference in its entirety; and/or with solar panels or solar cells or PV devices that are singulated or segmented or trenched or grooved, or that are flexible and/or rollable and/or foldable, and/or that include “blind gaps” or non-transcending gaps or craters. Some embodiments may provide a flexible and rollable PV cell or solar cell; wherein a silicon body or semiconductor body or semiconductor substrate or semiconductor wafer has non-transcending craters or “blind gaps” that penetrate into between 75 percent and 99 percent of a total thickness of the semiconductor body (or wafer, or substrate), and that do not penetrate into an entirety of the total thickness of the semiconductor body (or wafer, or substrate); wherein said non-transcending craters or “blind gaps” increase flexibility/or and mechanical resilience and/or mechanical shock absorption of the PV cell. In some embodiments, some, or most, or all of the non-transcending craters or “blind gaps” contain a filler material having mechanical force absorption properties, which provides mechanical shock absorption properties and/or mechanical force dissipation properties to the PV cell.

In some embodiments, each of the solar cells is rollable and flexible by itself; and is a single PV device or is a single PV article, that is comprised of a single semiconductor substrate or a single semiconductor wafer or a single semiconductor body; which is monolithic, e.g., is currently, and has been, a single item or a single article or a single component that was formed as (and remained) a single component; such that each solar cell is not formed as a collection or two or more separate units or as a collection of two or more entirely-separated or entirely-discrete or entirely-gapped units that were arranged or placed together in proximity to each other yet onto a metal foil or onto a metal film or onto a flexible or elastic foil or film.

In some embodiments, each single solar cell that is flexible and rollable by itself, is not a collection and is not an arrangement and is not an assembly of multiple discrete solar cells of PV modules, that each one of them has its own discrete and fully separated semiconductor substrate and/or its own discrete and fully separated semiconductor wafer and/or its own discrete and fully separated semiconductor body, and that have been merely placed to assembled or arranged together (or mounted together, or connected together) onto or beneath a flexible foil or a flexible film; but rather, the each single solar cell has a single unified semiconductor substrate or semiconductor body or semiconductor wafer that is common to, and is shared by, all the sub-regions or areas or portions of that single solar cell which includes therein (in that unified single semiconductor substrate or wafer or body) those non-transcending craters or non-transcending gaps or “blind gaps” that penetrate only from one side (and not from both sides), which do not reach all the way through and do not reach all the way to the other side of the unified single semiconductor substrate or wafer or body.

In some embodiments, each solar cell may be, or may include, a mono-crystalline PV cell or solar panel or solar cell, a poly-crystalline PV cell or solar panel or solar cell, a flexible PV cell or solar cell that is an Interdigitated Back Contact (IBC) solar cell having said semiconductor wafer with said set of non-transcending gaps, and/or other suitable type of PV cell or solar cell.

Some portions of the discussion above and/or herein may relate to regions or segments or areas, of the semiconductor body or substrate or wafer (or PV cell, or PV device); yet those “segments” are still touching each other and/or inherently connected to each other and/or non-separated from each other, as those “segments” are still connected by at least a thin portion or a thin bottom-side surface of the semiconductor substrate (or wafer, or body), which still holds and includes at least 1 (or at least 2, or at least 3, or at least 5, or at least 10, or at least 15, or at least 20, or at least 25, or at least 33; but not more than 50, or not more than 40) percent of the entire depth or the entire thickness (or the maximum thickness or depth) of the semiconductor substrate or body or wafer; as those “segments” are still connected at their base through such thin layer, and those “segments” have between them (or among them) the non-transcending gaps or the “blind gaps” or the non-transcending craters that thus separate those “segments” but that do not fully divide or fully break or fully isolate any two such neighboring “segments” from each other. Upon its production, and prior to attaching the solar cells onto the floating medium layer, each such flexible and rollable solar cell is freestanding and carrier-less and non-supported.

In some embodiments, the non-transcending gaps or the “blind gaps” or craters or slits or grooves, are introduced and are formed only at a first side or at a first surface of the semiconductor substrate or body or wafer, and are not formed at both of the opposite surfaces (or sides) thereof.

In some embodiments, the non-transcending gaps or the “blind gaps” or craters or slits or grooves, are introduced and are formed only at a first side or at a first surface of the semiconductor substrate or body or wafer, that is intended to face the sunlight or the light, or that is the active side of the PV device or PV cell, or that is intended to be the active side of the PV device or PV cell, or that is intended to be the electricity-generating side or surface that would generated electricity based on incoming sunlight or light or based on the PV effect; and they are not formed at the other (e.g., opposite, non-active) side or surface (e.g., the side that is not intended to be facing the sunlight or the light, or the side that is not intended to be producing electricity based on the PV effect).

In other embodiments, the non-transcending gaps or the “blind gaps” or craters or slits or grooves, are not introduced and are not formed at the side or surface of the semiconductor substrate or body or wafer, that is intended to face the sunlight or the light, or that is the active side of the PV device or PV cell, or that is intended to be the active side of the PV device or PV cell, or that is intended to be the electricity-generating side or surface that would generated electricity based on incoming sunlight or light or based on the PV effect; but rather, those non-transcending gaps or the “blind gaps” or craters or slits or grooves are formed at the other (e.g., opposite, non-active) side or surface, which is the side that is not intended to be facing the sunlight or the light, or the side that is not intended to be producing electricity based on the PV effect. Some implementations with this structure may advantageously provide the mechanical shock absorption and the mechanical forces dissipation capability, yet may also provide or maintain or achieve an increased level of PV-based electricity production since the gaps do not reduce the area of the light-exposed side or the light-facing side of the PV device.

In still other embodiments, the non-transcending gaps or the “blind gaps” or craters or slits or grooves, are introduced and are formed at both sides or at both surfaces of the semiconductor substrate or body or wafer; yet with an offset among the gaps of the first side and the gaps of the second side, in a zig-zag pattern of those gaps which zig-zag across the two sides of the semiconductor wafer or substrate or body; for example, a first gap located at the top surface on the left; then, a second gap located at the bottom surface to the right side of the first gap and not overlapping at all with the first gap; then, a third gap located at the top surface to the right side of the second gap and not overlapping at all with the second gap; then, a fourth gap located at the bottom surface to the right side of the third gap and not overlapping at all with the third gap; and so forth. In such structure, for example, any single point or any single location or any single region of the remaining semiconductor wafer or substrate or wafer, may have a gap or a crater or a “blind gap” only on one of its two sides, but not on both of its sides.

In yet other embodiments, the non-transcending gaps or the “blind gaps” or craters or slits or grooves, are introduced and are formed at both sides or at both surfaces of the semiconductor substrate or body or wafer; not necessarily with an offset among the gaps of the first side and the gaps of the second side, and not necessarily in a zig-zag pattern; but rather, by implementing any other suitable structure or pattern that still provides the mechanical shock resilience, and while also maintaining a sufficiently-thin layer of semiconductor substrate or body or wafer that is not removed and that is resilient to mechanical shocks and mechanical forces due to the craters or gaps that surround it.

Some embodiments may include and/or may utilize one or more units, devices, connectors, wires, electrodes, and/or methods which are described in United States patent application publication number US 2016/0308155 A1, which is hereby incorporated by reference in its entirety. For example, some embodiments may include and may utilize an electrode arrangement which is configured to define or create a plurality of electricity collection regions, such that within each of the collection regions, at least two sets of conducting wires are provided such that they are insulated from each other, and the at least two sets of conducting wires are connected either in parallel or in series between the collection regions to thus provide accumulating voltage of charge collection. Some embodiments may include an electric circuit for reading-out or collection or aggregation of the generated electricity, configured as an electrode arrangement, including conducting wires arranged in the form of nets covering zones of a pre-determined area. The electrodes arrangement may be configured or structured to be stretched (e.g., rolled out) along the surface of the PV cell, and may be formed by at least two sets of conducting wires, and may cover a plurality of collection zones or collection regions.

Within each of the electricity collection zones or electricity aggregation zones, the different conducting wires are insulated from each other, to provide a certain voltage between them. At a transition between zones, the negative charges collecting conductive wire of one zone, is electrically connected to the positive charges collecting conductive wire of the adjacent or the consecutive zone. Thus, within each of the collection zones, the different sets of conducting wires are insulated from each other, while being connected in series between the zones. This configuration of the electrode arrangement allows accumulation or aggregation of electric voltage generated by charge collection along the surface of the PV device. The configuration of the electrode arrangement provides a robust electric collection structure.

The internal connections between the sets of conducting wires allow energy collection even if the surface being covered is not continuous, e.g., if a perforation occurs in the structure of the net. This feature of the electrode arrangement allows for using this technique on any surface exposed to photon radiation, while also allowing discontinuity if needed and without limiting or disrupting the electric charge collection.

Some embodiments provide a system comprising: a solar panel, comprising one or more electricity-generating layers that are configured to generate electricity from light via a photovoltaic effect. An edge of the solar panel has a set of one or more protrusions selected from the group consisting of: (i) a set of spaced-apart protrusions, (ii) a single elongated flexible beam-shaped protrusion. A maximum thickness of each protrusion is greater than a maximum thickness of the edge of the solar panel. The set of one or more protrusions is insertable or slidable, sideways, along a direction that is parallel to said edge, into an elongated hollow cavity of a holding rail of a Mechanical Joining Unit. The set of one or more protrusions, upon its insertion into the elongated hollow cavity of the holding rail, is trapped within said holding rail and maintains said solar panel in place relative to said Mechanical Joining Unit.

In some embodiments, said solar panel is a flexible and rollable solar panel, that does not break and that continues to convert light into electricity even subsequent to being subjected to flexing operation and rolling operations and unrolling operations.

In some embodiments, said set of one or more protrusions is held by a flexible and rollable strip, that is connected to said edge of the solar panel; wherein said flexible and rollable strip, which holds the set of one or more protrusions, is capable of respectively flexing and rolling in response to flexing forces and rolling forces that are applied to said solar panel.

In some embodiments, said set of one or more protrusions comprises a single elongated protrusion, that is an elongated flexible beam (e.g., a beam having a square or rectangular profile or cross-section; or a beam having a circular or oval or egg-shaped profile or cross-section; or a beam having other suitable profile or cross-section), which is capable of being inserted (or slid, or pushed) sideways into the elongated hollow cavity of said holding rail of the Mechanical Joining Unit, and which is capable of flexing or curving outside of said holding rail to facilitate insertion of the elongated flexible beam into the elongated hollow cavity of the holding rail.

In some embodiments, said set of one or more protrusions comprises a set of mushroom-shaped or lollipop-shaped protrusions; wherein each protrusion has: (I) a base rod having a first width, and (II) a cap or a bead having a second width that is greater than said first width of the base rod.

In some embodiments, the Mechanical Joining Unit comprises an additional holding rail; wherein an additional solar panel is connected, via an additional set of one or more protrusions, to said additional holding rail of said Mechanical Joining Unit; wherein said Mechanical Joining Unit and said solar panel and said additional solar panel form together a conjoined solar module.

In some embodiments, the Mechanical Joining Unit comprises an additional holding rail; wherein an infrastructure element is connected, via an additional set of one or more protrusions, to said additional holding rail of said Mechanical Joining Unit; wherein said Mechanical Joining Unit causes said solar panel to remain mechanically connected to said infrastructure element. In some embodiments, said infrastructure element is an object selected from the group of: a roof, a roof tile, a tile, a house, a building, a wall, a fence, a pole, a vehicular component, a floating device that can float on water.

In some embodiments, the holding rail and the additional holding rail are two back-to-back oppositely-facing holding rails that directly touch one another and that have a common panel.

In some embodiments, the holding rail and the additional holding rail are two holding rails that are not directly touching each other back-to-back, and that are interconnected via one or more rods or panels.

In some embodiments, the Mechanical Joining Unit comprises: said holding rail that defines a first elongated cavity that is configured to receive the edge of said solar panel;
said additional holding rail that defines a second elongated cavity that is configured to receive the edge of said additional solar panel; an additional rail defined by at least three panels, forming a third elongated cavity that is configured to store or hold therein metal wires that transport PV-generated electricity from said solar panel and from said additional solar panel.

In some embodiments, at least 75 percent (or, in some embodiments, at least 80 or 85 or 90 percent) of a length of said edge of the solar panel, is connected to said set of one or more protrusions which suffices for holding in place said edge within said holding rail of the Mechanical Joining Unit.

In some embodiments, the system further comprises: a stopper (or blocker) unit, located at an opening of the holding rail, to block exit or sliding-out of the one or more protrusions of the solar panel from the elongated hollow cavity of the holding rail.

In some embodiments, a Mechanical Joining Unit comprises: (I) a first elongated holding rail having a first elongated hollow cavity defined by a first pair of teeth or lips, configured to receive and hold therein a set of one or more protrusions of an edge of a first solar panel that has complementing protrusions that are capable of being slid into said first elongated cavity; (II) a second elongated holding rail having a second elongated hollow cavity defined by a second pair of teeth or lips, configured to receive and hold therein a set of one or more protrusions of an edge of a second solar panel that has complementing protrusions that are capable of being slid into said second elongated cavity. In some embodiments, the Mechanical Joining Unit is configured to mechanically connect to and hold the first solar panel via its protrusions upon their insertion into the first elongated holding rail, and is configured to mechanically connect to and hold the second solar panel via its protrusions upon their insertion into the second elongated holding rail, and is configured to form a conjoined solar module comprising said first solar panel and said second solar panel.

In some embodiments, the first holding rail and the second holding rail are implemented as two back-to-back oppositely-facing holding rails that directly touch one another and that have at least one common panel.

In some embodiments, the first holding rail and the second holding rail are implemented as two holding rails that do not directly touch each other and that are mechanically interconnected via a set of one or more panels or rods.

In some embodiments, the Mechanical Joining Unit further comprises: an additional set of elongated panels that define a third elongated hollow cavity, that is configured to store or hold therein metal wires that transport PV-generated electricity from said first solar panel and/or from said second solar panel.

In some embodiments, a conjoined solar module comprises the Mechanical Joining Unit as described; and at least said first solar panel and said second solar panel, or comprises at least two solar panels that are conjoined via the Mechanical Joining Unit; or comprises N solar panels that are conjoined (e.g., in a row, or in a column, or as a linear segment or linear strip) via N−1 mechanical joining units, wherein each mechanical joining unit holds two neighboring solar panels of the N solar panels, wherein N is a natural number greater than one.

In some embodiments, a conjoined solar module comprises: a particular number (N) of discrete solar panels; and at least N−1 units of the Mechanical Joining Unit according to the above, that mechanically interconnect or conjoin said N discrete solar panels.

Some embodiments provide a method of producing a conjoined solar module by conjoining two or more solar panels. The method comprises: (a) providing a Mechanical Joining Unit, which comprises: (a1) a first elongated holding rail having a first elongated hollow cavity defined by a first pair of teeth or lips, configured to receive and hold therein a set of one or more protrusions of an edge of a first solar panel that has complementing protrusions that are capable of being slid into said first elongated cavity; (a2) a second elongated holding rail having a second elongated hollow cavity defined by a second pair of teeth or lips, configured to receive and hold therein a set of one or more protrusions of an edge of a second solar panel that has complementing protrusions that are capable of being slid into said second elongated cavity. The method further comprises: (b) inserting (or sliding, or pushing) the set of one or more protrusions of the edge of the first solar panel, into the first elongated cavity of said first elongated holding rail of the Mechanical Joining Unit. The method further comprises: (c) inserting (or sliding, or pushing) the set of one or more protrusions of the edge of the second solar panel, into the second elongated cavity of said first elongated holding rail of the Mechanical Joining Unit.

In some embodiments, the method further comprises: placing a first stopper element at an opening of the first holding rail, to block exit or sliding-out of the protrusions of the first solar panel from the first holding rail; placing a second stopper element at an opening of the second holding rail, to block exit or sliding-out of the protrusions of the second solar panel from the second holding rail.

Some embodiments provide a conjoined solar module, and a mechanical joining unit for mechanically conjoining multiple solar panels. A joining unit has two back-to-back elongated holding rails; each elongated holding rail comprises, or is defined by, a pair of two elongated tooth-shaped or L-shaped or C-shaped protrusions (e.g., each such holding rail having a profile or a cross-section that is generally C-shaped). The first elongated rail has an elongated hollow cavity, and receives therein a set of beads or mushroom-shaped protrusions or lollipop-shaped protrusions that are connected to an edge of a first solar panel. Similarly, the second elongated rail has an elongated hollow cavity, and receives therein a set of beads or mushroom-shaped protrusions or lollipop-shaped protrusions that are connected to an edge of a second solar panel. Optionally, the mechanical joining unit has an additional elongated rail that defines an elongated cavity for storing metal wires that transport electricity generated by the solar panels. Optionally, each solar panel is flexible or rollable.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments”, “some embodiments”, and/or similar terms, may indicate that the embodiment(s) so described may optionally include a particular feature, structure, or characteristic, but not every embodiment necessarily includes the particular feature, structure, or characteristic. Furthermore, repeated use of the phrase “in one embodiment” does not necessarily refer to the same embodiment, although it may. Similarly, repeated use of the phrase “in some embodiments” does not necessarily refer to the same set or group of embodiments, although it may.

As used herein, and unless otherwise specified, the utilization of ordinal adjectives such as “first”, “second”, “third”, “fourth”, and so forth, to describe an item or an object, merely indicates that different instances of such like items or objects are being referred to; and does not intend to imply as if the items or objects so described must be in a particular given sequence, either temporally, spatially, in ranking, or in any other ordering manner.

Functions, operations, components and/or features described herein with reference to one or more embodiments, may be combined with, or may be utilized in combination with, one or more other functions, operations, components and/or features described herein with reference to one or more other embodiments. Some embodiments may thus comprise any possible or suitable combinations, re-arrangements, assembly, re-assembly, or other utilization of some or all of the modules or functions or components that are described herein, even if they are discussed in different locations or different chapters of the above discussion, or even if they are shown across different drawings or multiple drawings.

While certain features of some demonstrative embodiments have been illustrated and described herein, various modifications, substitutions, changes, and equivalents may occur to those skilled in the art. Accordingly, the claims are intended to cover all such modifications, substitutions, changes, and equivalents.

What is claimed is:

1. A system comprising:
a solar panel, comprising one or more electricity-generating layers that are configured to generate electricity from light via a photovoltaic effect;
wherein an edge of the solar panel has a set of one or more protrusions selected from the group consisting of: (i) a set of spaced-apart protrusions, (ii) a single elongated flexible beam-shaped protrusion;
wherein a maximum thickness of each protrusion is greater than a maximum thickness of the edge of the solar panel;
wherein said set of one or more protrusions is insertable or slidable, sideways, along a direction that is parallel to said edge, into an elongated hollow cavity of a holding rail of a Mechanical Joining Unit;
wherein said set of one or more protrusions, upon its insertion into the elongated hollow cavity of the holding rail, is trapped within said holding rail and maintains said solar panel in place relative to said Mechanical Joining Unit.

2. The system according to claim 1,
wherein said solar panel is a flexible and rollable solar panel, that does not break and that continues to convert light into electricity even subsequent to being subjected to flexing operation and rolling operations and unrolling operations.

3. The system according to claim 1,
wherein said solar panel is a flexible and rollable solar panel, that does not break and that continues to convert light into electricity even subsequent to being subjected to flexing operation and rolling operations and unrolling operations;
wherein said set of one or more protrusions is held by a flexible and rollable strip, that is connected to said edge of the solar panel;
wherein said flexible and rollable strip, which holds the set of one or more protrusions, is capable of respectively flexing and rolling in response to flexing forces and rolling forces that are applied to said solar panel.

4. The system according to claim 1,
wherein said set of one or more protrusions comprises a single protrusion, that is an elongated flexible beam, which is capable of being inserted sideways into the elongated hollow cavity of said holding rail of the Mechanical Joining Unit, and which is capable of flexing or curving outside of said holding rail to facilitate insertion of the elongated flexible beam into the elongated hollow cavity of the holding rail.

5. The system according to claim 1,
wherein said set of one or more protrusions comprises a set of mushroom-shaped or lollipop-shaped protrusions,
wherein each protrusion has: (I) a base rod having a first width, and (II) a cap or a bead having a second width that is greater than said first width of the base rod.

6. The system according to claim 1,
wherein the Mechanical Joining Unit comprises an additional holding rail;
wherein an additional solar panel is connected, via an additional set of one or more protrusions, to said additional holding rail of said Mechanical Joining Unit;
wherein said Mechanical Joining Unit and said solar panel and said additional solar panel form together a conjoined solar module.

7. The system according to claim 1,
wherein the Mechanical Joining Unit comprises an additional holding rail;
wherein an infrastructure element is connected, via an additional set of one or more protrusions, to said additional holding rail of said Mechanical Joining Unit;
wherein said Mechanical Joining Unit causes said solar panel to remain mechanically connected to said infrastructure element.

8. The system according to claim 7,
wherein said infrastructure element is an object selected from the group of:
a roof, a roof tile, a tile,
a house, a building, a wall, a fence, a pole,
a vehicular component,
a floating device that can float on water.

9. The system according to claim 6,
wherein the holding rail and the additional holding rail are two back-to-back oppositely-facing holding rails that directly touch one another and that have a common panel.

10. The system according to claim 6,
wherein the holding rail and the additional holding rail are two holding rails that are not directly touching each other back-to-back, and that are interconnected via one or more rods or panels.

11. The system according to claim 6,
wherein the Mechanical Joining Unit comprises:
said holding rail that defines a first elongated cavity that is configured to receive the edge of said solar panel;
said additional holding rail that defines a second elongated cavity that is configured to receive the edge of said additional solar panel;
an additional rail defined by at least three panels, forming a third elongated cavity that is configured to store or hold therein metal wires that transport PV-generated electricity from said solar panel and from said additional solar panel.

12. The system according to claim 1,
wherein at least 75 percent of a length of said edge of the solar panel, is connected to said set of one or more protrusions which suffices for holding in place said edge within said holding rail of the Mechanical Joining Unit.

13. The system according to claim 1,
further comprising:
a stopper unit, located at an opening of the holding rail, to block exit or sliding-out of the one or more protrusions of the solar panel from the elongated hollow cavity of the holding rail.

14. A Mechanical Joining Unit comprising:
a first elongated holding rail having a first elongated hollow cavity defined by a first pair of teeth or lips, configured to receive and hold therein a set of one or more protrusions of an edge of a first solar panel that has complementing protrusions that are capable of being slid into said first elongated cavity;
a second elongated holding rail having a second elongated hollow cavity defined by a second pair of teeth or lips, configured to receive and hold therein a set of one or more protrusions of an edge of a second solar panel that has complementing protrusions that are capable of being slid into said second elongated cavity;
wherein the Mechanical Joining Unit is configured to mechanically connect to and hold the first solar panel via its protrusions upon their insertion into the first elongated holding rail, and is configured to mechanically connect to and hold the second solar panel via its protrusions upon their insertion into the second elongated holding rail, and is configured to form a conjoined solar module comprising said first solar panel and said second solar panel.

15. The Mechanical Joining Unit according to claim 14,
wherein the first holding rail and the second holding rail are implemented as two back-to-back holding rails that directly touch one another and that have at least one common panel.

16. The Mechanical Joining Unit according to claim 14,
wherein the first holding rail and the second holding rail are implemented as two holding rails that do not directly touch each other and that are mechanically interconnected via a set of one or more panels or rods.

17. The Mechanical Joining Unit according to claim 14,
further comprising:
an additional set of elongated panels that define a third elongated hollow cavity, that is configured to store or hold therein metal wires that transport PV-generated electricity from said first solar panel and/or from said second solar panel.

18. A conjoined solar module,
comprising the Mechanical Joining Unit according to claim 14,
and comprising at least said first solar panel and said second solar panel.

19. A conjoined solar module,
comprising a particular number (N) of discrete solar panels,
and comprising at least N−1 units of the Mechanical Joining Unit according to claim 14, that mechanically interconnect said N discrete solar panels.

20. A method of producing a conjoined solar module by conjoining two or more solar panels, the method comprising:
(a) providing a Mechanical Joining Unit, which comprises:
(a1) a first elongated holding rail having a first elongated hollow cavity defined by a first pair of teeth or lips, configured to receive and hold therein a set of one or more protrusions of an edge of a first solar panel that has complementing protrusions that are capable of being slid into said first elongated cavity;
(a2) a second elongated holding rail having a second elongated hollow cavity defined by a second pair of teeth or lips, configured to receive and hold therein a set of one or more protrusions of an edge of a second solar panel that has complementing protrusions that are capable of being slid into said second elongated cavity;
(b) inserting the set of one or more protrusions of the edge of the first solar panel, into the first elongated cavity of said first elongated holding rail of the Mechanical Joining Unit;
(c) inserting the set of one or more protrusions of the edge of the second solar panel, into the second elongated cavity of said first elongated holding rail of the Mechanical Joining Unit.

21. The method according to claim 20, further comprising:
placing a first stopper element at an opening of the first holding rail, to block exit or sliding-out of the protrusions of the first solar panel from the first holding rail;
placing a second stopper element at an opening of the second holding rail, to block exit or sliding-out of the protrusions of the second solar panel from the second holding rail.
